(19) United States
(12) Patent Application Publication
(10) Pub. No.: US 2014/0297915 A1
(43) Pub. Date: Oct. 2, 2014

(54) PERIPHERAL COMPONENT INTERCONNECT DEVICE AND ELECTRONIC DEVICE WITH PERIPHERAL COMPONENT INTERCONNECT PORT

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/098,545

(22) Filed: Dec. 6, 2013

(30) Foreign Application Priority Data
Mar. 29, 2013 (TW) 102111568

(51) Int. Cl. G06F 13/40; G06F 9/44

(52) U.S. Cl. CPC G06F 13/4068; G06F 9/4411
USPC 710/313; 713/2

(57) ABSTRACT

An electronic device includes a peripheral component interface (PCI) port, a first storage unit storing a basic input/output system (BIOS), a second storage unit storing a relationship table defining a number of register values and PCI setting information, and a processing unit. The PCI port is used to connect to at least one PCI device. The first storage unit stores a basic input/output system (BIOS). The processing unit runs the BIOS when the electronic device is starting up. When the BIOS is running, the BIOS reads a register value from the PCI device connected to the PCI port and determines a setting information of the PCI port corresponding to the register value according to the relationship table. The BIOS then sets the pins the PCI port according to the determined setting information.

### BACKGROUND

1. Technical Field

The present disclosure relates to interconnect devices, particularly, to a peripheral component interconnect device, and an electronic device with a peripheral component interconnect port.

2. Description of Related Art

Peripheral component interconnect (PCI) ports are widely used in many electronic devices, such as tablet computers, desktop computers, and portable computers. To decrease the size of the electronic device, a design of connecting many PCI devices via a single PCI port is adopted. A single PCI port with sixteen pins can connect with two PCI devices with eight pins, or four PCI devices with four pins. The PCI devices connected to the same PCI port can be the same or different devices. Typically, when the PCI port connects with more than one PCI device, a basic input/output system (BIOS) of the electronic device should know how many PCI devices are connected to the single PCI port and how to divide the PCI port to groups of pins matching the PCI devices. However, in current designs, the PCI devices can not communicate this information to the BIOS. Instead, the BIOS must be set manually, which is inconvenient.

A peripheral component interconnect device, and an electronic device with a peripheral component interconnect to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a first embodiment of an electronic device connected to a number of peripheral component interface devices.

FIG. 2 is a schematic diagram of an embodiment of a relationship table.

FIG. 3 is a schematic diagram of a second embodiment of an electronic device connected to a number of peripheral component interface devices.

### DETAILED DESCRIPTION

Embodiments of the present disclosure will be described with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

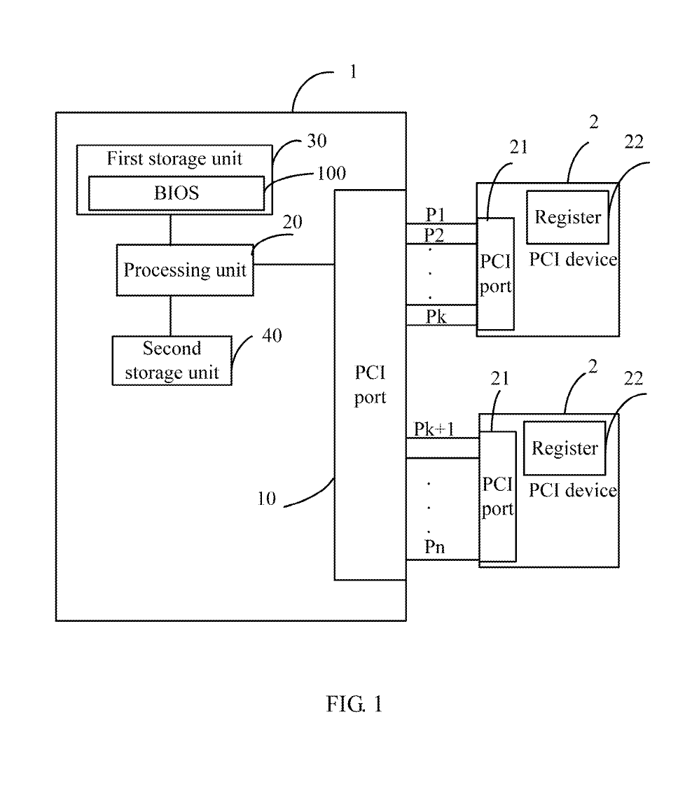

FIG. 1 illustrates an electronic device 1 connected to a number of peripheral component interface (PCI) devices 2. The electronic device 1 includes a PCI port 10, a processing unit 20, a first storage unit 30, and a second storage unit 40. The first storage unit 30 stores a basic input /output system (BIOS) 100. In the embodiment, the first storage unit 30 is an electrically erasable programmable read only memory (EEPROM), the BIOS 100 is burned in the first storage unit 30. The second storage unit 40 can be an EEPROM, a hard disk, or a memory. The processing unit 20 can be a central processing unit, a single chip, or a digital signal processor. The PCI device 2 includes a PCI port 21.

The PCI port 10 is used to connect to the device PCI port 21 of at least one PCI device 2. The PCI device 2 can be a graphics processing unit card or a multimedia card. The PCI port 10 includes a number of pins P1-Pn.

The processing unit 20 is connected to the PCI port 10, the first storage unit 30, and the second storage unit 40. The processing unit 20 is used to communicate with the PCI device connected to the PCI port 10, and run the BIOS 100 when the electronic device 1 is starting up.

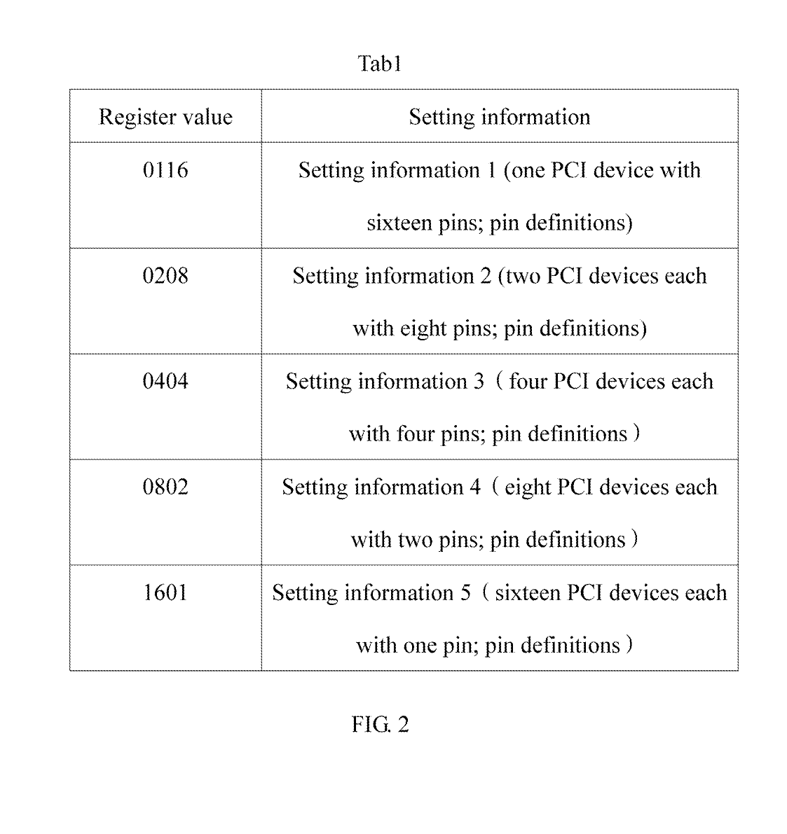

FIG. 2 shows that the second storage unit 40 stores a relationship table Tab1 defining relationships between a number of register values and PCI setting information.

When the electronic device 100 is starting up, the processing unit 10 runs the BIOS 100. When the BIOS 100 is running, the BIOS 100 scans the PCI port 10 and determines whether the PCI port 10 connects any PCI device 2. The BIOS 100 then determines whether the PCI device 2 stores a register value. If yes, the BIOS 100 reads the register value from the PCI device 2 connected to the PCI port 10 and determines a setting information of the PCI port 10 corresponding to the register value according to the relationship table Tab1. The BIOS 100 then sets the pins P1-Pn of the PCI port 100 according to the determined setting information.

In the embodiment, the PCI device 2 also includes a register 22 which pre-stores the register value.

In detail, the setting information includes a number of the PCI devices 2 connected to the PCI port 10, a number of pins of each PCI device 2, and pin definitions. The BIOS 100 sets the pins P1-Pn of the PCI port 100 according to the determined setting information as follows. In detail, the BIOS 100 distributes the pins P1-Pn of the PCI port 10 to a number of groups. In one embodiment, the total number of the groups is equal to the number of the PCI devices 2, and the total number of pins of each group is equal to the total number of pins of each PCI device 2. The BIOS 100 then configures the pins of each groups of the PCI device 2 to match the corresponding PCI device 2 according to the pin definitions. The processing unit 20 can then communicate with the PCI devices 2 connected to the PCI port 10 after the pins of the PCI port 10 have been configured.

FIG. 2 is one embodiment of the PIC port 10 having sixteen pins. If the number of the PCI devices 2 connected to the PCI port 10 is two, and the number of pins of each PCI device 2 is eight, then the register value pre-stored in each PCI device 2 is “0208” as shown in FIG. 2.

When the BIOS 100 scans the register value of the PCI device 2 as “0208,” the BIOS 100 then determines the setting information corresponding to the register value “0208” is setting information 2 according to the relationship table Tab1, and then configures the pins P1-Pn of the PCI port 10 according to the setting information 2. In detail, the BIOS 100 divides the pins P1-Pn of the PCI port 10 into two groups of eight pins, and then configures the pins of each group according to the pin definitions of the setting information 2.

In the embodiment, a total number of the pins of all of the PCI devices 2 can be equal to the number of pins P1-Pn of the PCI port 10, or can be less than the number of pins P1-Pn of the PCI port 10. For example, the number of pins P1-Pn of the PCI port 10 is sixteen, and the PCI port 10 can connect one PCI device 2 with eight pins, or connect two PCI devices 2 each with four pins.

In the embodiment, the BIOS 100 reads the register value from one PCI device 2 via any one of the pins P1-Pn of the PCI port 10.

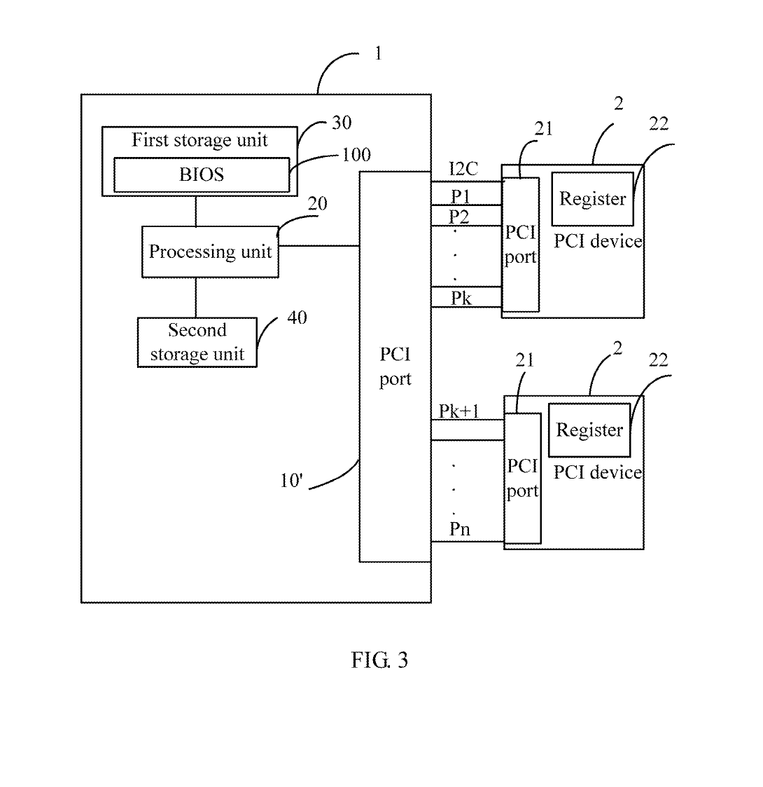

FIG. 3 shows that in another illustrated embodiment, the PCI port 10′ also includes a serial pin I2C. When the PCI port 10′ is connected to a number of PCI devices 2, at least one PCI device 2 can connect with the serial pin I2C. The BIOS 100 reads the register value from the PCI device 2 via the serial pin I2C.

In the embodiment, the PCI port 10, 10′ can be a PCI Express port, a PCIX port, or a normal PCI port.

The electronic device 1 can be a tablet computer, a desktop computer, a server, a portable computer, a digital photo frame, a digital camera, and any electronic device with a PCI port.

According to present disclosure, the BIOS 100 can automatically set the pins of the PCI port 10 according to the PCI devices 2 connected to the PCI port 10.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An electronic device comprising:
a peripheral component interface (PCI) port configured to connect to at least one PCI device;
a first storage unit storing a basic input/output system (BIOS);
a second storage unit storing a relationship table defining a plurality of register values and PCI setting information; and
a processing unit connected to the PCI port, the first storage unit, and the second storage unit, and configured to communicate with the PCI device connected to the PCI port, and run the BIOS when the electronic device is starting up;
wherein, when the BIOS is running, the BIOS scans the PCI port to determine whether the PCI port is connected to the at least one PCI device, and then determines whether the PCI device stores a register value when determining the PCI port connects the PCI device; when the PCI device stores the register value, the BIOS reads the register value from the PCI device connected to the PCI port and determines a setting information of the PCI port corresponding to the register value according to the relationship table, and the BIOS further sets the pins of the PCI port according to the determined setting information.

2. The electronic device according to claim 1, wherein the setting information comprises a total number of the PCI devices connected to the PCI port, a total number of pins of each PCI device, and pin definitions; the BIOS divides the pins of the PCI port into a plurality of groups, wherein a total number of the groups is equal to the total number of the PCI devices, and a total number of pins of each group is equal to the total number of pins of each PCI device respectively; the BIOS further configures the pins of each group to match the corresponding PCI device according to the pin definitions.

3. The electronic device according to claim 2, wherein the BIOS reads the register value from one PCI device via any one of the pins of the PCI port.

4. The electronic device according to claim 2, wherein the PCI port further comprises a serial pin, and the BIOS reads the register value from one PCI device via the serial pin.

5. The electronic device according to claim 2, wherein the PCI port is a PCI Express port, a PCIX port, or a normal PCI port.

6. The electronic device according to claim 2, wherein the electronic device is a desktop computer, a tablet computer, a portable computer, or a server.

7. A peripheral component interface (PCI) device comprising:
a PCI port configured to connect to a PCI port of an electronic device;
a register storing a register value corresponding to a setting information, wherein, the setting information comprises information of a total number of the PCI devices connected to the PCI port of the electronic device, a total number of pins of each PCI device and pin definitions.

8. The PCI device according to claim 7, wherein, the PCI device is a graphics processing unit card or a multimedia card.
